(19) United States
(12) Patent Application Publication
(10) Pub. No.: US 2019/0095097 A1
(43) Pub. Date: Mar. 28, 2019

(54) INPUT DEVICE

(71) Applicant: Onkyo Corporation, Osaka (JP)

(72) Inventor: Tokinori TADA, Osaka (JP)

(21) Appl. No.: 16/120,336

(22) Filed: Sep. 3, 2018

(30) Foreign Application Priority Data
Sep. 28, 2017 (JP) 2017-188796

(51) Int. Cl. G06F 3/0488; G06F 3/0482

(52) U.S. Cl. CPC G06F 3/04886; G06F 3/0482

(57) ABSTRACT

An input device comprising: circuitry, wherein the circuitry displays a character button which is for receiving selection of a character and is for receiving change of multiple characters, a change button which is for receiving change to a capital letter of a character which is displayed on the character button, and a character input column, displays the character that the circuitry receives selection when the circuitry receives the selection of a character by the character button, and changes characters which are displayed on the character button to capital letters when the circuitry receives the change to a capital letter by the change button.

### CROSS-REFERENCE TO RELATED APPLICATIONS

This application claims priority to Japanese Application No. 2017-188796, filed Sep. 28, 2017, the entire contents of which are incorporated herein by reference.

### FIELD

The present invention relates to an input device which is for inputting characters and so on.

### BACKGROUND

In an input device which is for inputting characters and so on, there is an input device which includes a small type touch panel (for example, see JP 2012-083838 A.). In such device, conventionally, in a character input screen which is operated by only tap, when a user switches capital letter/small letter of alphabet, the user inputs a character, and changes capital letter/small letter by a capital small change button. FIG. 10 is a diagram illustrating a conventional character input screen. When the user would like to input a character “A”, as illustrated in FIG. 11, the user selects an “abc” button and inputs “a” first. Next, the user selects the capital small change button (A/a), and a small letter “a” changes to capital letter “A” as illustrated in FIG. 12. When the user decides on the capital letter “A”, the user selects the character button (for example, “jkl” button) other than the “abc” button. Alternatively, the user moves an input position by a left right button, or spends (waits for) a certain period of time after inputting “A”.

However, in character input by a keyboard for a conventional personal computer, it is natural that a small letter changes to a capital letter by inputting a character with pushing a shift button. In recent years, by spread of smartphones, it is general that the user taps (selects) a button which corresponds to the shift button, changes to a capital letter, and selects a character. For this reason, select order of buttons is select of character and change of capital and small. Select order of buttons becomes reverse to the smartphones, and there is a problem that it is hard for the user to input characters.

### SUMMARY OF THE INVENTION

According to one aspect of the disclosure, there is provided an input device comprising: circuitry, wherein the circuitry displays a character button which is for receiving selection of a character and is for receiving change of multiple characters, a change button which is for receiving change to a capital letter of a character which is displayed on the character button, and a character input column, displays the character that the circuitry receives selection when the circuitry receives the selection of a character by the character button, and changes characters which are displayed on the character button to capital letters when the circuitry receives the change to a capital letter by the change button.

### BRIEF DESCRIPTION OF THE DRAWINGS

FIG. 1 is a block diagram illustrating a constitution of a digital audio player according to an embodiment of the present invention.

FIG. 2 is a diagram illustrating a character input screen.

FIG. 3 is a diagram illustrating the character input screen.

FIG. 4 is a diagram illustrating the character input screen.

FIG. 5 is a diagram illustrating the character input screen.

FIG. 6 is a diagram illustrating the character input screen.

FIG. 7 is a diagram illustrating the character input screen.

FIG. 8 is a diagram illustrating the character input screen.

FIG. 9 is a diagram illustrating the character input screen.

FIG. 10 is a diagram illustrating a conventional character input screen.

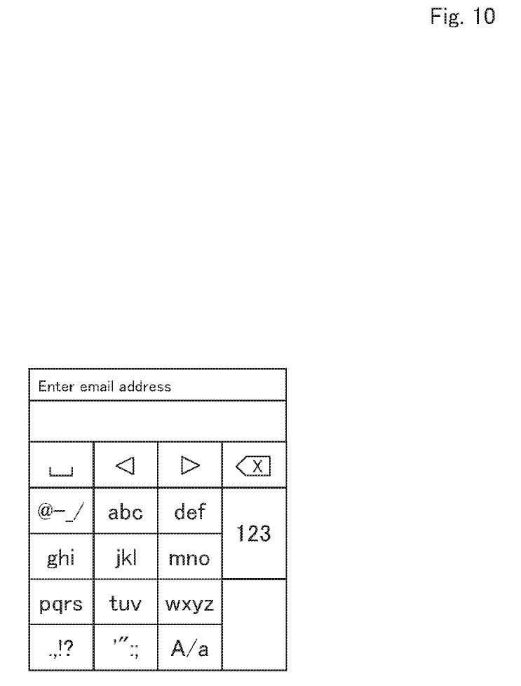

FIG. 11 is a diagram illustrating the conventional character input screen.

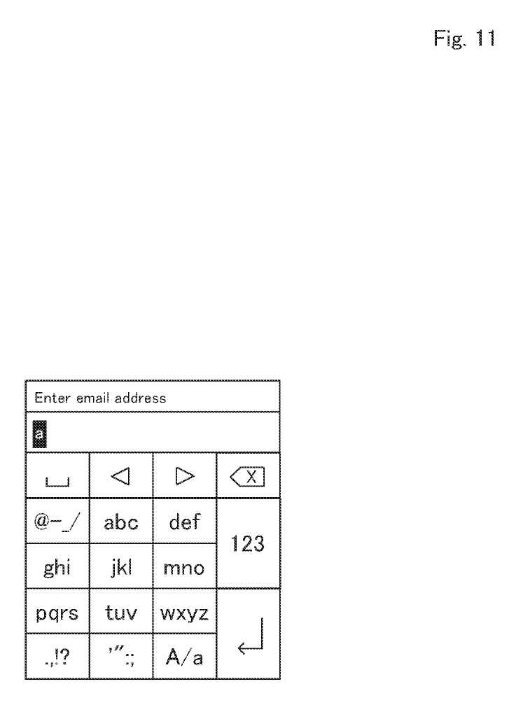

FIG. 12 is a diagram illustrating the conventional character input screen.

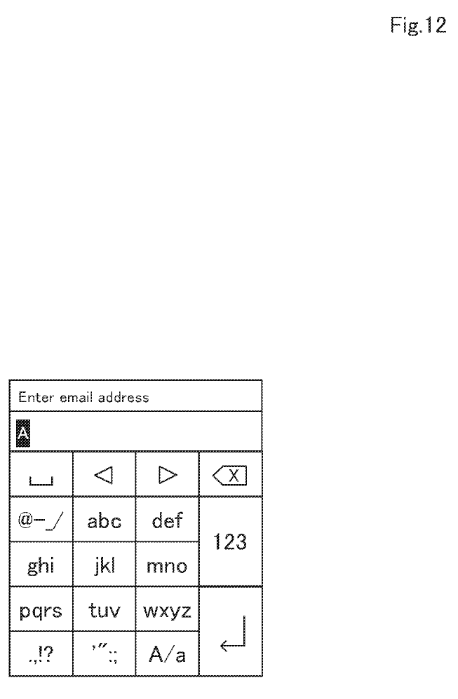

### DETAILED DESCRIPTION OF THE PREFERRED EMBODIMENTS

An objective of the present invention is to provide a device that a user can input characters easily.

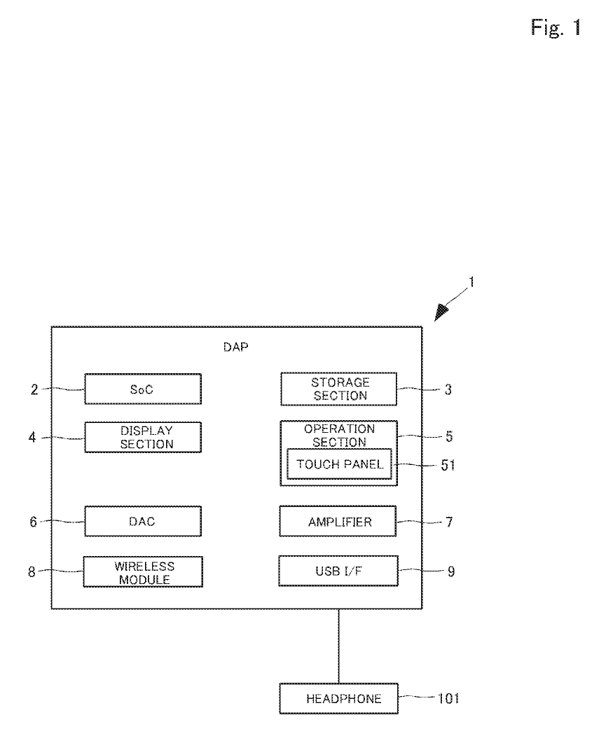

An embodiment of the present invention is described below. FIG. 1 is a block diagram illustrating a constitution of a digital audio player according to an embodiment of the present invention.

The digital audio player (hereinafter, referred as to “DAP”) 1 outputs analog audio data to a headphone 101. The headphone 101 outputs audio outside based on the analog audio data.

As illustrated in FIG. 1, the DAP 1 (input device) includes an SoC (System on Chip) 2, a storage section 3, a display section 4, an operation section 5, a D/A converter (hereinafter, referred as to “DAC”) 6, an amplifier 7, a wireless module 8, and a USB interface (hereinafter, referred as to “USB I/F”) 9.

The SoC 2 (circuitry, controller) has a CPU (Central Processing Unit), a DSP (Digital Signal Processor), a memory and so on, and controls respective sections composing the DAP 1. The storage section 3 is composed of a flash memory which stores programs such as an OS program, application programs and so on and various data such as digital audio data (contents) and so on. Not limited to illustrated constitution, the storage section 3 may be an HDD (Hard Disk Drive) or the like.

The display section 4 (circuitry) displays various images (including still images and moving images) and is composed of a liquid crystal panel. The operation section 5 includes operation keys which are for performing various settings and a touchpanel 51 (circuitry) which is linked with the display section 4. The touch panel 51 is provided on the display section 4. The touch panel 51 is for receiving touch operation, slide operation, and so on. The user can perform various character input, settings and so on via the operation section 5.

The SoC 2 outputs the digital audio data of I2S system to the DAC 6. The DAC 6 D/A-converts the digital audio data to the analog audio data. The analog audio data is input to the amplifier 7 from the DAC 6. The amplifier 7 amplifies the analog audio data which is D/A-converted by the DAC 6, and outputs the amplified analog audio data to the headphone 101.

The wireless module 10 is for performing wireless communication according to Bluetooth (registered trademark) standard and Wi-Fi standard. The USB I/F 11 is for performing communication according to USB standard.

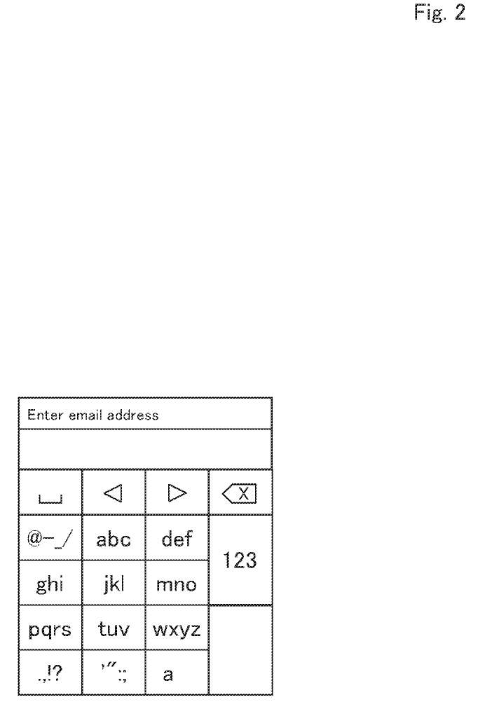

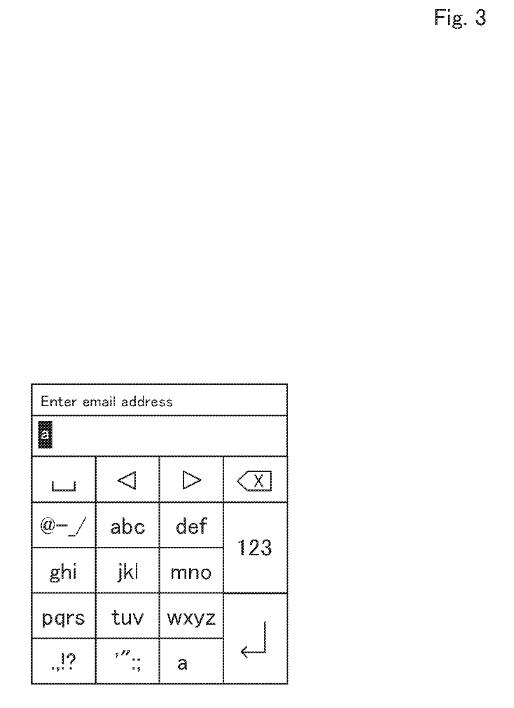

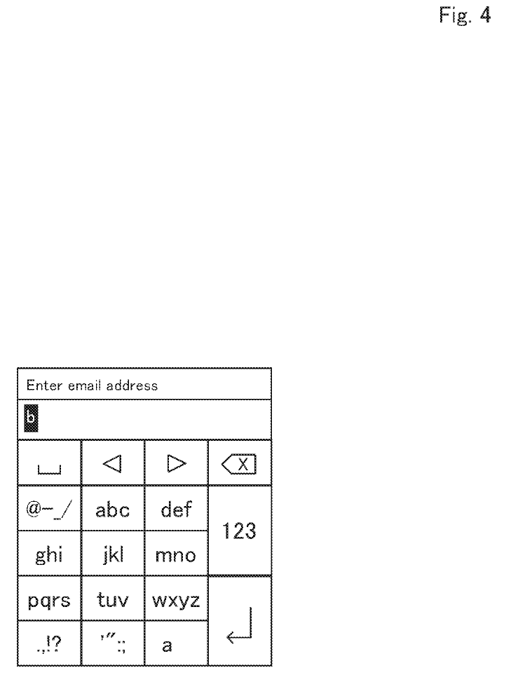

FIG. 2 is a diagram illustrating a character input screen in the DAP 1. The SoC 2 displays the character input screen on the display section 4. As illustrated in FIG. 2, multiple character buttons, a change button, a character input column (blank part in FIG. 2) and so on are included in the character input screen. The character buttons are buttons for receiving selection of characters and change of multiple characters. The character buttons are an “abc” button, a “def” button and so on. Herein, 26 alphabets are assigned to eight character buttons. For example, in a state as illustrated in FIG. 2, when the SoC 2 receives selection (tap) of a character by the “abc” button by the touch panel 51, as illustrated in FIG. 3, the SoC 2 displays the first character “a” of the “abc” button that the SoC 2 receives the selection on the character input column. Next, in a state as illustrated in FIG. 3, when the SoC 2 receives the selection of the “abc” button by the touch panel 51 again, as illustrated in FIG. 4, the SoC 2 displays a character“b” which is the next character of “a” on the character input column. The SoC 2 receives selection of a character by the “abc” button by the touch panel 51, and changes the character which is displayed on the character input column to “a”→“b”→“c”→“a” . . . in order.

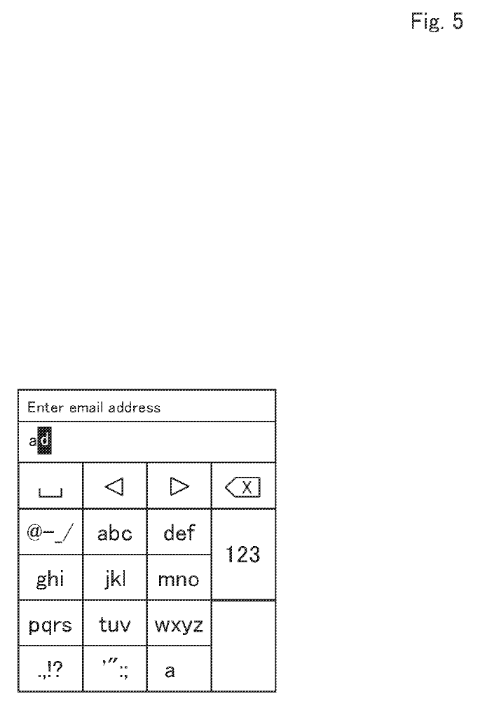

Meanwhile, in a state as illustrated in FIG. 3, when the SoC 2 receives selection of a character by the “def” button by the touch panel 51, as illustrated in FIG. 5, the SoC 2 displays the first character “d” of the “def” button that the SoC 2 receives the selection, and decides on “a” which is displayed on the character input column. When the SoC 2 receives operation of a left right button or does not receive any operation for a certain period of time after the SoC 2 displays the character “a” on the character input column, the SoC 2 decides on “a”. It is the same below.

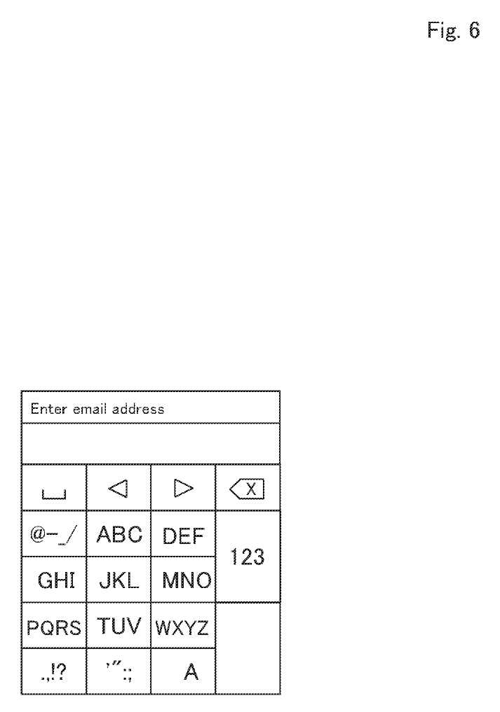

A change button (a button which is displayed with “a” in FIG. 2) is a button for receiving a change to a capital letter of characters which are displayed on the character buttons. In a state as illustrated in FIG. 2, when the SoC 2 receives the change to a capital letter by the change button via the touch panel 51, as illustrated in FIG. 6, the SoC 2 changes characters which are displayed on the character buttons to capital letters. For example, the “abc” button is changed to the “ABC” button. Further, the SoC 2 changes “a” which is displayed on the change button to a capital letter “A”.

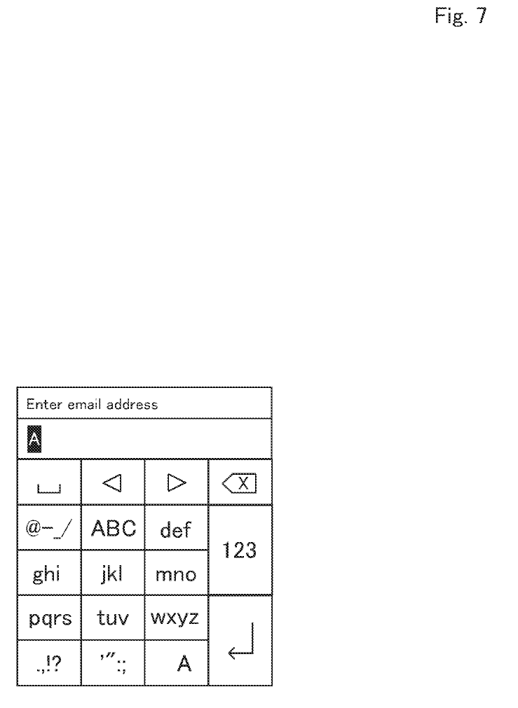

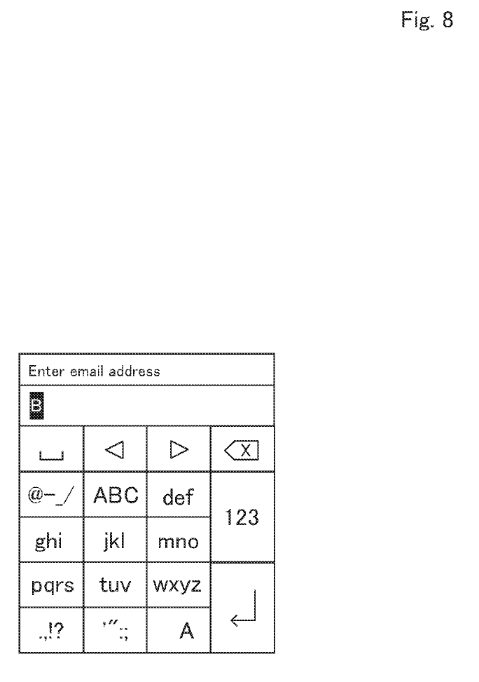

When the SoC 2 receives selection of a character by the “ABC” button by the touch panel 51, as illustrated in FIG. 7, the SoC 2 displays the first character “A” of the “ABC” button that the SoC 2 receives the selection on the character input column. In this time, the SoC 2 changes characters (for example, “DEF”) of the character buttons other than the “ABC” button that the SoC 2 receives the selection to small letters (for example, “def”). Further, when the SoC 2 displays capital letters on multiple character buttons, after the SoC 2 receives selection of character “A” by the “ABC” button, and the SoC 2 receives the selection of “ABC” button again by the touch panel 51, as illustrated in FIG. 8, the SoC 2 displays a character “B” which is the next character of “A” on the character input column.

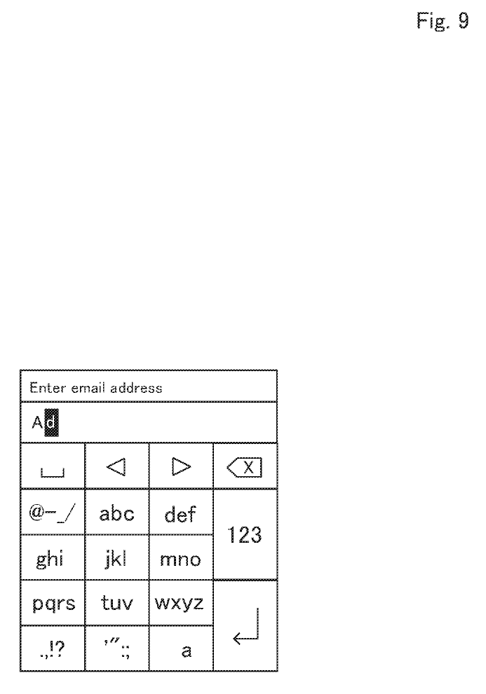

After the SoC 2 changes characters (for example, “DEF”) of the character buttons other than the “ABC” button to small letters, when the SoC 2 receives selection of the “def” button that the SoC 2 changes to a small letter by the touch panel 51, as illustrated in FIG. 9, the SoC 2 displays the first character “d” of the “def” button that the SoC 2 receives the selection on the character input column, and the SoC 2 decides on a capital character “A” that the SoC 2 displays on the character input column. Further, after the SoC 2 changes characters of the character buttons other than the “ABC” button that the SoC 2 received the selection to small letters, when the SoC 2 receives the selection of the character button that the SoC 2 changes to small letters by the touch panel 51, the SoC 2 changes the “ABC” button that the SoC 2 displays capital letters to small letters “abc”.

When the SoC 2 displays small letters on all character buttons (FIG. 2 to FIG. 5, and FIG. 9), the SoC 2 displays a small letter “a” on the change button. Further, when the SoC 2 displays capital letters on at least any one of the character buttons (FIG. 6 to FIG. 8), the SoC 2 displays a capital letter “A” on the change button.

As described above, it the present embodiment, when the SoC 2 receives change to a capital letter by the change button by the touch panel 51, the SoC 2 changes characters (for example, “abc”) which are displayed on the character buttons to capital letters (for example, “ABC”). Thus, the user can input characters with flow which is the same as smartphone operation because the user can select characters by the character buttons on which capital letters are displayed. Therefore, according to the present embodiment, the user who gets used to smartphone operation can input characters easily without discomfort.

The embodiment of the present invention is described above, but the mode to which the present invention is applicable is not limited to the above embodiment and can be suitably varied without departing from the scope of the present invention, as exemplified below.

In the above described embodiment, as a device which functions as an input device, the DAP is illustrated. Not limited to this, the input device may be a smartphone, a tablet PC or the like other than the DAP.

The present invention can be suitably employed in an input device which is for inputting characters and so on.

What is claimed is:

1. An input device comprising:
circuitry, wherein
the circuitry displays
a character button which is for receiving selection of a character and is for receiving change of multiple characters,
a change button which is for receiving change to a capital letter of a character which is displayed on the character button, and
a character input column,
displays the character that the circuitry receives selection when the circuitry receives the selection of a character by the character button, and
changes characters which are displayed on the character button to capital letters when the circuitry receives the change to a capital letter by the change button.

2. The input device according to claim 1,
wherein the circuitry
displays multiple character buttons, and
displays the first character of the character button that the circuitry receives selection on the character input column when the circuitry displays capital letters on the multiple character buttons and receives the selection of a character by any of the character buttons.

3. The input device according to claim 2,
wherein the circuitry changes characters of the character button other than the character button that the circuitry receives selection to small letters when the circuitry displays capital letters on the multiple character buttons and receives the selection of a character by any of the character buttons.

4. The input device according to claim 2,
wherein the circuitry displays the next character on the character input column after the circuitry displays capital letters on the multiple character buttons and receives selection of a character by any of the character buttons, and then the circuitry receives selection of the same character button again.

5. The input device according to claim 3,
wherein the circuitry displays the first character of the character button that the circuitry receives selection and decides on the capital letter that the circuitry displays on the character input column after the circuitry changes the character of the character button other than the character button that the circuitry receives selection to a small letter and then the circuitry receives selection of the character button that the circuitry changes to small letters.

6. The input device according to claim 3,
wherein the circuitry changes the character button that the circuitry displays capital letters to small letters after the circuitry changes the character of the character buttons other than the character button that the circuitry receives the selection to small letters when the circuitry receives the selection of the character button that the circuitry changes to small letters.

7. The input device according to claim 1,
wherein the circuitry changes a character which is displayed on the change button to a predetermined capital letter when the circuitry receives change to a capital letter by the change button.

8. The input device according to claim 7,
wherein the circuitry displays a predetermined capital letter on the change button when the circuitry displays a capital letter on at least any one of the character buttons, and displays a predetermined small letter on the change button when the circuitry displays a small letter on all character buttons.

9. An input device comprising:
a touch panel;
a display section; and
a controller, wherein
the controller displays
a character button which is for receiving selection of a character and is for receiving change of multiple characters,
a change button which is for receiving change to a capital letter of a character which is displayed on the character button, and
a character input column on the display section,
displays the character that the controller receives selection when the controller receives the selection of a character by the character button by the touch panel, and
changes characters which are displayed on the character button to capital letters when the controller receives the change to a capital letter by the change button by the touch panel.

10. A storage medium in which a control program of a input device which comprises circuitry, the control program of the input device allows the circuitry to display
a character button which is for receiving selection of a character and is for receiving change of multiple characters,
a change button which is for receiving change to a capital letter of a character which is displayed on the character button, and
a character input column,
display the character that the circuitry receives selection when the circuitry receives the selection of a character by the character button, and
change characters which are displayed on the character button to capital letters when the circuitry receives the change to a capital letter by the change button.
